(19) United States
(12) Patent Application Publication
(10) Pub. No.: US 2015/0108360 A1
(43) Pub. Date: Apr. 23, 2015

(54) MEASUREMENT OF SUNSCREEN PROTECTION USING SPIN COATED SUBSTRATES

(71) Applicant: Suncare Research Laboratories, LLC, Winston-Salem, NC (US)

(72) Inventors: Joseph W. Stanfield, Winston-Salem, NC (US); William J. Stanfield, Winston-Salem, NC (US)

(21) Appl. No.: 14/407,084

(22) PCT Filed: Jun. 11, 2013
(86) PCT No.: PCT/US13/45051

§ 371 Date: Dec. 11, 2014

Related U.S. Application Data
(60) Provisional application No. 61/658,443, filed on Jun. 12, 2012.

(51) Int. Cl. G01N 21/59; B05D 1/00; G01N 21/84

(52) U.S. Cl. CPC G01N 21/59; G01N 21/84; B05D 1/005; G01N 2201/02; G01N 2201/061
USPC 250/372; 250/453.11; 427/160

(57) ABSTRACT

Methods for spin coating plates for in vitro determination of sunscreen protection factors (SPF) are disclosed.

### TECHNICAL FIELD

The use of “spin coating” for creating uniform sunscreen films is described. An appropriate range of selected thickness values, on flat, roughened or contoured, transparent plates, is used for determining the sun protection factor (SPF) of a sunscreen formula. More particularly, described herein is a precise, reproducible method for creating sets of representative sunscreen films with thickness distributions approximating those of sunscreen formulas applied to human skin. The ultraviolet energy (UVR) transmission spectrum of each representative film is measured, and the UVR transmission spectra are combined mathematically, using empirically determined weighting factors, to yield the overall UVR transmission spectrum, which permits computation of the SPF.

### BACKGROUND

Sunscreens protect against sunburn by absorbing UVR from sunlight before it penetrates the skin. The degree of protection by a sunscreen is described by the sun protection factor (SPF). Typically, the SPF is measured in vivo on human volunteer subjects by applying 2 mg/cm² of a sunscreen formula to an area of the mid-back, allowing the sunscreen to dry for 15 minutes, and administering a series of five increasing doses of UVR, simulating sunlight, to skin sites treated with the sunscreen. Another series of five increasing UVR doses is applied within a skin area without the sunscreen. After 16 to 24 hours, the irradiated skin sites are examined for sunburn. The SPF is the lowest dose of UVR that caused mild sunburn in the sunscreen-treated area divided by the lowest dose of UVR that caused mild sunburn in the area without sunscreen. The label SPF of a sunscreen formula is based on the average SPF for 10 volunteers. Label SPF values currently range from 8 to more than 100. See U.S. Food and Drug Administration, 21 C.F.R. Parts 201 and 310, Federal Register, Vol. 76, No. 117, Friday, Jun. 17, 2011, 35620-35665.

Because SPF measurement requires administration of UVR to humans, and UVR is a known carcinogen, it is desirable to replace the current in vivo method of measuring SPF with non-invasive methods. See Cole, Forbes, & Davies, Photochem. Photobiol. 43: 275-284 (1986). Current non-invasive methods for measurement of sunscreen SPF include in vitro measurements on artificial substrates that simulate the skin surface, and mathematical models based on known UVR transmission spectra of active ingredients. The latter approach is known as “in silico” measurement. Both approaches determine the transmission spectrum of the sunscreen, which permits computation of the SPF.

Current methods for in vitro measurements of sunscreen protection rely on polymethylmethacrylate (PMMA) or fused silica substrates, with application of weighed amounts of the sunscreen formula that are “spotted” over the surface in small droplets and rubbed with a bare finger that has been conditioned by immersion in the sunscreen formula so that presumably, no material is added or removed. Published instructions for application typically specify 30 seconds of light rubbing and spreading, followed by 30 seconds of rubbing with high pressure. It is difficult to achieve a uniform surface of a sunscreen film on a substrate, and generally accepted that the correct application technique is learned by intensive training and practice. There are an ISO Standard and several published methods for obtaining in vitro measurements of transmission spectra and computing the SPF. However, there is no ISO Standard, regulatory agency protocol, or currently accepted method for in vitro measurements of SPF. See Rohr et al., Skin Pharmacol. Physiol. 7(23): 201-212 (2010); Diffey, Int. J. Cosmet. Sci. 16: 4 7-52 (1994); Broad Spectrum Test Procedure, U.S. Food and Drug Administration, 21 C.F.R. Parts 201 and 310, Federal Register, Vol. 76, No. 117, Friday, Jun. 17, 2011, 35620-35665; Colipa Project Team IV, In vitro Photoprotection Methods, Method for the in vitro Determination of UVA Protection Provided by Sunscreen Products, Guideline, 2011; International Organization for Standardization (ISO), International Draft Standard, ISO/DIS 24443, Determination of sunscreen UVA photoprotection in vitro.

The basic in vitro measure of UV protection is the transmission spectrum, which permits computation of the SPF. The logarithmic transformation of the transmission spectrum yields the absorbance spectrum that is used for determination of the UVA/UVB absorbance ratio, the critical wavelength, and the spectral uniformity index. See Stanfield, In vitro techniques in sunscreen development in: Shaath, N. Sunscreens: Regulations and Commercial Development 3^{rd} ed., Boca Raton, Fla., Taylor & Francis Group (2005); Measurement of UVA:UVB ratio according to the Boots Star rating system (2011 revision) Boots UK Ltd, Nottingham, UK; Diffey, Int. J. Cosmet. Sci. 16: 47-52 (1994); Diffey, Int. J. Cosmet. Sci., 31: 63-68 (2009).

Changes in absorbance spectra associated with applied UV doses also permit quantitative assessment of the photostability of a sunscreen formula. See Stanfield, Osterwalder, & Herzog Photochem. Photobiol. Sci. 9: 489-494 (2010).

In vitro measurement of sunscreen protection presents a significant challenge: the set of film thicknesses used for determination of transmission and absorbance spectra must adequately approximate the final configuration of the sunscreen formula after application on the skin surface, rather than matching the topography of the skin itself. Measurement systems must provide an appropriate optical configuration and sufficient dynamic range and wavelength accuracy. Because many sunscreen formulas are not photostable, the measurement procedures and algorithms must account for changes in SPF and absorbance spectra during exposure to UVR.

Commercially available substrates for measuring sunscreen absorbance spectra are constructed of polymethylmethacrylate (PMMA), with known roughness values (Sa) and include the Schönberg sandblasted substrate, with a 2 μm roughness value (Schönberg GmbH & Co KG; Hamburg, Germany), the Helioscreen HD-6 molded substrate, with a 6 μm roughness value (Helioscreen; Creil, France).and the “Skin-Mimicking” substrate, with a 17 μm roughness value (Shiseido, Yokohama, Japan). See Miura et al., Photochem. Photobiol. 88: 475-482 (2012).

Of the above substrates, only the “Skin-Mimicking Substrate” replicates the roughness value of skin topography, which is about 17 μm, and permits application of 2 mg/cm² of sunscreen. Ferrero and coworkers have evaluated the performance of substrates with various roughness values. See Ferrero et al., IFSCC Magazine 9(2): 97-108 (2006). Miura has reported results of a ring test comparing SPF results for substrates with 6 μm and 16 μm roughness values. See Miura, Comparison of high and low roughness substrates. Presentation to ISO TC217 WG7, Baltimore, Md., Jun. 22, 2009. All three substrates yield reasonable SPF estimates under a limited range of conditions. However, no known substrate has achieved consistently accurate measurements of in vivo SPF values.

Current substrates do not achieve consistently accurate measurements of in vivo SPF values for at least two reasons: First, current substrates do not adequately address the complex factors that determine the final configuration of the sunscreen film on skin. When a sunscreen film is applied to human skin, the multiple thickness values of the resulting film are determined by skin topography, the sheer forces and thixotropic behavior exhibited during product application and the viscoelastic properties of the skin. The resulting SPF depends on the final distribution of thickness values that determine the effective UVR absorbance of the film. Because the SPF is exponentially related to the thickness of the sunscreen film, thin areas protect much less than thicker areas, and thus have a greater influence on the SPF. When sunscreens are applied to artificial substrates by hand, there is a “waviness” of the top surface that strongly affects the absorbance value and the repeatability of measurements. See O'Neill, J. Pharmaceut. Sci. 73: 888-891 (1984). In order to replicate the actual thickness distribution of a sunscreen film when 2 mg/cm² is applied to the skin, the substrate must not only have a roughness value (Sa) that is similar to that of the skin, but must simulate the final geometry of the sunscreen film on skin. Researchers have attempted to compensate for the multiple factors of application by employing special protocols for the product application procedure, such as rubbing for various lengths of time at various pressures, and intensive training of laboratory personnel. These measures have improved accuracy for particular formulas, but optimum application techniques differ for different types of formulas. No substrate or application technique is wholly effective for even a small subset of the wide range of sunscreen formula types and characteristics on the market.

Second, several widely used sunscreen ingredients are not photostable, and almost all sunscreen formulas degrade and/or “settle” on the skin to some extent, which means that their ability to absorb UVR changes as UVR is absorbed and the temperature is increased. The time course and extent of photodegradation and other changes, such as evaporation of volatile ingredients and skin penetration, depends on the thickness of the sunscreen film, but with different mechanisms than the thickness dependence of UVR absorbance. Therefore, the substrate must simulate the final film thickness distribution on skin, not only to duplicate the UVR absorbance on skin, but also to account for potential photodegradation and other changes, as well as the multiple factors of application.

Use of spin coating to apply sunscreens to flat, roughened, or contoured substrates can eliminate the “waviness” of the top surface of a sunscreen film to achieve repeatable, uniform applications to substrates, which are not possible when the product is applied by hand, even when special application protocols are used. Use of spin coating of sunscreens, with and without dilution, can also permit creation of an appropriate range of film thickness values corresponding to the resultant configuration of the sunscreen film on skin. Finally, the effects of photodegradation and other changes, as well as the effects of skin elasticity during application, can be incorporated in the set of film thickness values that are combined mathematically, using empirically derived weighting factors to compute the transmission spectrum. See Ferrero et al., J. Cosmet. Sci. 54: 463-481 (2003).

The use of spin coating can also provide solutions to some of the problems encountered when in silico methods are used for theoretical calculation of absorbance spectra and SPF. In silico methods rely on calculation of effective transmission or absorbance spectra using quantitative UV spectra of the UV absorbing ingredients. These spectra are available in databases obtained from UV spectroscopic measurements in dilute solutions, and taking filter concentrations in the respective sunscreen compositions into account. For the simulation of realistic sunscreen film transmittance from filter composition and spectral data, the film irregularity profile is considered, by applying a relevant mathematical film profile model. In addition, photoinstabilities of the active ingredients that absorb UVR are accounted for in terms of the respective photodegradation constants, which are also available in experimentally determined databases. Thus, starting with available UV spectroscopic and photokinetic data, it is possible to simulate the dynamics of the absorbance spectra of sunscreen films of given filter compositions under irradiation. See Herzog & Osterwalder, Cosmet. Sci. Tech. 62-70 (2011); Herzog, J. Cosmet. Sci. 53: 11-26, (2002); Herzog et al., J. Pharm. Sci. 93(7): 1780-1795 (2004). The performance of current in silico methods is illustrated by the BASF Sunscreen Simulator, which is a public, internet-based resource that incorporates an in silico method to predict SPF, based on the concentrations of a list of the active ingredients that are approved by the FDA or other agencies (available at: www.sunscreensimulator.basf.com/Sunscreen_Simulator/).

When the active ingredients and their concentrations for a commercially available sunscreen formula labeled as SPF 50 and containing 3% avobenzone, 15% homosalate, 5% octisalate, and 6% oxybenzone were entered into the input section of the simulator page, the output SPF value was 21.5. Likewise, when the active ingredients of a formula labeled as SPF 30 and containing 7.5% octinoxate, 2% octocrylene, 3% oxybenzone, and 6% zinc oxide, were entered, the output SPF value was 25.2. Finally, when the active ingredients of a formula labeled as SPF 15 and containing 2% avobenzone, 5% octisalate, and 2% oxybenzone, were entered, the output SPF value was 8.3. The discrepancies between label SPF and SPF values computed by the in silico method suggest that the available databases for computing effects of film thickness distributions based on percentages of active ingredients, and corrections for photoinstabilities of ingredients may be incomplete, or may utilize inaccurate algorithms. Further, in silico methods do not account for vehicle ingredients that may have a significant effect on the SPF. The limited accuracy of in silico methods could be improved by actual measurements of the dynamic behavior of appropriate films of sunscreen formulas created by spin coating, rather than relying upon databases of UV spectroscopic measurements in dilute solutions.

### SUMMARY

Described herein is a precise, repeatable method for creating a set of uniform sunscreen films, with a range of selected thickness values, on flat, roughened or contoured transparent plates, for determining transmission spectra and SPF of sunscreen formulas using spin-coating procedures. Methods for approximating the distribution of sunscreen thicknesses after application to human skin, and mathematically combining the measured film absorbance spectra and SPF values using empirically determined weighting factors will yield improved measurements of the SPF.

Rather than simulating skin topography, this approach relies upon an array of thickness layers of a sunscreen formula representing an appropriate range of thicknesses on skin.

One embodiment described herein is a method for spin coating a substrate with a sunscreen for determining the SPF and absorbance or transmission spectra of the sunscreen, the method comprising: (a) selecting a flat or roughened optically transparent substrate; (b) applying a sunscreen to the substrate; and (c) spinning the substrate to coat the substrate with the sunscreen.

In one aspect described herein, the sunscreen is applied to the substrate prior to initiating spinning.

In another aspect described herein, the sunscreen is applied to the substrate after initiating spinning.

In another aspect described herein, sunscreen is continuously or intermittently applied.

In another aspect described herein, the sunscreen is diluted prior to application.

In another aspect described herein, the sunscreen is diluted with acetone, ether, methanol, ethanol, isopropanol, butanol, or other organic or water-soluble solvents.

In another aspect described herein, the sun protection factor, absorbance, or transmission spectra of the sunscreen of the sunscreen are unknown.

In another aspect described herein, spin coating creates uniform, repeatable sunscreen films of pre-determined thickness values.

In another aspect described herein, the sunscreen is photolabile.

In another aspect described herein, the spinning velocity is constant; progressively increasing; progressively decreasing; intermittent cycles of varying velocities; or cycles or combinations thereof.

In another aspect described herein, the spinning velocity is 600 to 10,000 revolutions per minute

In another aspect described herein, the substrate comprises a defined height and comprises indentations comprising a plurality of separate or concentric shapes at progressively increasing depths.

In another aspect described herein, a plurality of thicknesses of a sunscreen on one or more substrates is prepared.

Another embodiment described herein is an in vitro method for determining the SPF and absorbance or transmission spectra of a sunscreen, the method comprising: (a) applying sunscreen onto a plate by spin coating; (b) applying a continuous or intermittent light source to the sunscreen and plate; and (c) measuring the transmission or absorbance of the sunscreen; (d) calculating the integrated absorbance spectrum; (e) analyzing the integrated absorbance spectrum; and (f) determining the sun protection factor.

In one aspect described herein, the spin coating creates uniform, reproducible sunscreen films of pre-determined thickness values.

In another aspect described herein, the sunscreen is applied to the plate prior to initiating spinning.

In another aspect described herein, the sunscreen is applied to the plate after initiating spinning.

In another aspect described herein, the sunscreen is continuously or intermittently applied. In another aspect described herein, the sunscreen is diluted prior to application.

In another aspect described herein, the sunscreen is diluted with acetone, ether, methanol, ethanol, isopropanol, butanol, or other organic or water-soluble solvents.

In another aspect described herein, the sun protection factor, absorbance, or transmission spectra of the sunscreen of the sunscreen are unknown.

In another aspect described herein, the sunscreen is photolabile.

In another aspect described herein, the spinning velocity is constant; progressively increasing;

progressively decreasing; intermittent cycles of varying velocities; or cycles or combinations thereof.

In another aspect described herein, the spinning velocity is 600 to 10,000 revolutions per minute

In another aspect described herein, the plate comprises a defined height and indentations comprising a plurality of separate or concentric shapes at progressively increasing depths.

In another aspect described herein, a time course of absorbance or transmission of the sunscreen is measured.

In another aspect described herein, an integrated absorbance spectrum is calculated.

In another aspect described herein, films of different thicknesses are prepared for a sunscreen.

In another aspect described herein, multiple absorbance spectra for individual sunscreen films of different thickness values are combined to yield the SPF and absorbance spectra of a sunscreen formula having an unknown SPF.

### BRIEF DESCRIPTION OF THE DRAWINGS

FIG. 1 illustrates a graph of applied dose of ultra violet radiation versus the transmitted dose and a curve fit of the transmission equation.

FIG. 2 illustrates examples of flat substrates.

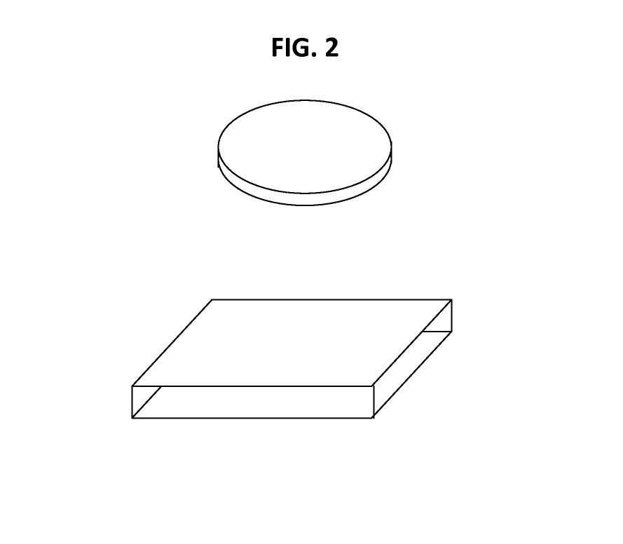

FIG. 3 illustrates examples of roughened substrates.

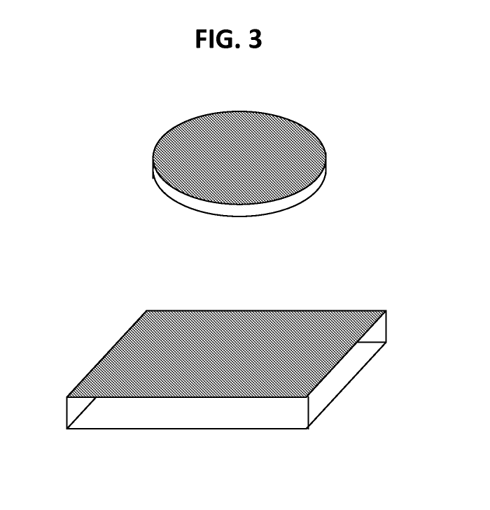

FIG. 4 illustrates examples of contoured substrates.

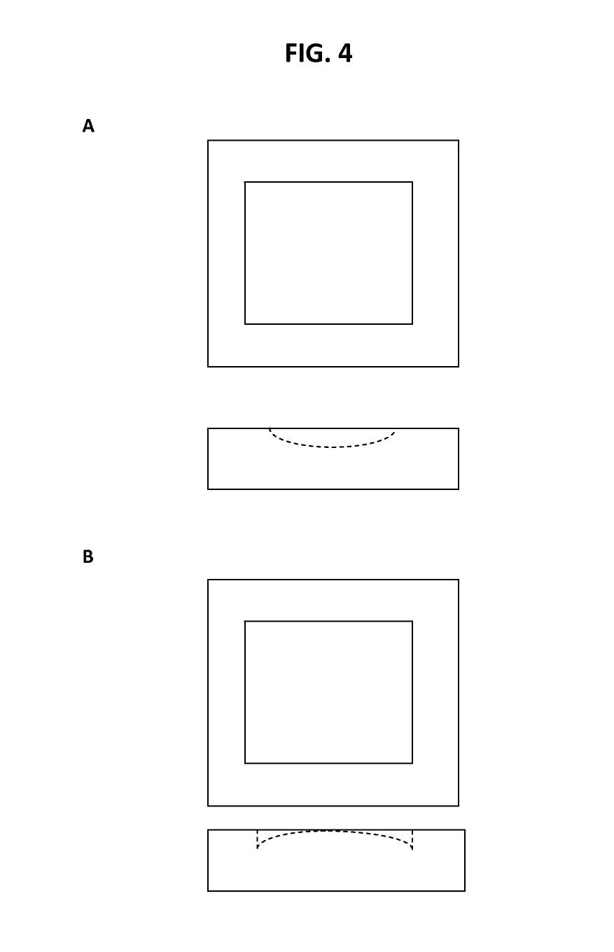

### DETAILED DESCRIPTION

The method described herein measures the SPF and absorbance spectra of a sample of uniform sunscreen films created by spin coating and combines the measurements to approximate the final distribution of thickness values.

### Spin Coating

Spin coating is a procedure that has been used for more than four decades in microfabrication industries for creating uniform thin films on flat surfaces. The process consists of application of a liquid to a plate and rotating the plate at high speed to spread the liquid over the plate by centrifugal force. Rotation is continued as the liquid spins over the edges of the plate, until the desired film thickness is achieved. Film thickness values in the range of interest, from less than one micrometer to more than 20 micrometers, may be achieved. See Hall et al., Polym. Eng. Sci. 38: 2039-2045 (1988); Luurtsema, G. Spin coating for rectangular substrates, Master's Thesis, University of California, Berkeley, (1997). Methods for spin coating substrates are described in U.S. Pat. Nos. 4,741,926 and 5,264,246, and U.S. Patent Application Publication No. US 2007/0006804, each of which is incorporated by reference herein for such teachings.

An advantage of spin coating is the ability to create reproducible uniform films on flat, roughened or contoured substrates, without the variability introduced by “waviness” of the upper surface of a films applied to flat or roughened surfaces by hand.

### EXAMPLES

### Example 1

### Measuring SPF and Absorbance Spectra of Spin Coated Thin Films

To create uniform films, sunscreen was applied liberally to the plate, and spun at 600 to 10,000 revolutions per minute (RPM) for a period of a few seconds to several minutes, depending on the sunscreen composition, viscosity, and the desired film thickness. Sunscreens were applied before spinning began or were continuously or intermittently applied during spinning. The sunscreen was applied in its original condition or diluted by as much as 10-fold with a suitable solvent, such as acetone, ether, methanol, ethanol, isopropanol, butanol, or other water-soluble or organic solvents.

Spinning was performed at a constant speed, at progressively increasing or decreasing speeds, or in cycles of varying speeds.

The plates were composed of optically transparent materials such as quartz, fused silica, optically clear glass, polymethylmethacrylate (PMMA), polystyrene, sapphire, ceramics, or a biological film or membrane. The plate thickness was from about 0.5 mm to about 10 mm.

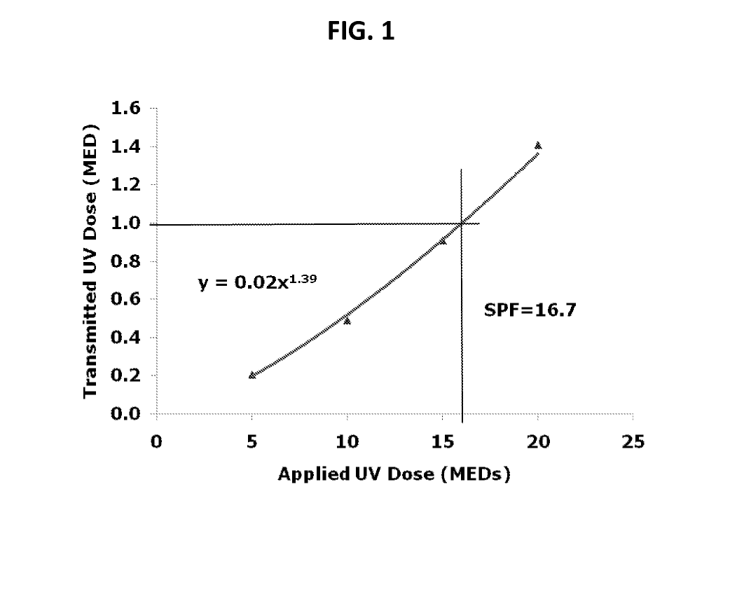

After the desired film thickness was achieved and spin coating was complete, a series of ultraviolet radiation (UVR) doses was administered to the film on the original plate (Applied Dose), and the corresponding cumulative UVR doses transmitted by the film were measured (Transmitted UV dose). See FIG. 1. The UV doses were expressed in MEDs where 1 MED was 2 SEDs (Standard Erythema Dose) See Erythema reference action spectrum and standard erythema dose, ISO/CIE Standard ISO 17166: 1999/CIE S 007-1998. The cumulative applied and transmitted UV doses were graphed, and a least squares power curve fit equation was computed in the form:

γ=αx^{β};

see FIG. 1. If an erythema-weighted radiometer was used, the irradiation and transmitted UV dose measurements can be performed continuously and simultaneously. See Kockott et al., Automatic in vitro evaluation of sun care products, in: Proceedings of the 21^{st} IFSCC Congress, Berlin (2000).

Because the applied dose that produces 1 transmitted MED corresponds to the SPF, the SPF was computed as follows:

SPF=(1/α)^{(1/β)}.

The value of β serves as an index of photostability. If β is equal to 1, the formula is photostable; if β is significantly greater than 1, the formula is not photostable.

If the UVR doses were measured spectroscopically, the integrated absorbance can be computed, as well as the SPF for a given sunscreen formula. This method for computing SPF and absorbance spectra is valid for photolabile sunscreen formulas, as well as photostable formulas. See Stanfield, Osterwalder, & Herzog, Photochem. Photobiol. Sci. 9: 489-494 (2010).

Thus, the SPF and absorbance spectra were computed for each of a variety of film thicknesses. The weighting factors for the measured film thickness were approximated by application of a Gamma distribution, with fine-tuning of the distribution parameters determined by trial and error with a small sample of measurements from formulas with known SPF values. See Ferrero et al., J. Cosmet. Sci. 54: 463-481 (2003).

The scope of the apparati or methods described herein includes all actual or potential combinations of aspects, embodiments, examples, and preferences herein described.

What is claimed is:

1. A method for spin coating a plate with a sunscreen for determining the SPF and absorbance or transmission spectra of the sunscreen, the method comprising:
(a) selecting a flat, roughened or contoured, optically transparent plate;
(b) applying a sunscreen to the plate; and
(c) spinning the plate to coat the substrate with a precise thickness of a sunscreen formula.

2. The method of claim 1, wherein the sunscreen is applied to the plate prior to initiating spinning.

3. The method of claim 1, wherein the sunscreen is applied to the plate after initiating spinning.

4. The method of claim 3, wherein sunscreen is continuously or intermittently applied.

5. The method of claim 1, wherein the sunscreen is diluted prior to application.

6. The method of claim 5, wherein the sunscreen is diluted with acetone, ether, methanol, ethanol, isopropanol, butanol, or other water-soluble or organic solvents.

7. The method of claim 1, wherein the sun protection factor, absorbance, or transmission spectra of the sunscreen of the sunscreen is unknown.

8. The method of claim 1, wherein spin coating creates uniform, repeatable sunscreen films of pre-determined thickness values.

9. The method of claim 1, wherein the sunscreen is photolabile.

10. The method of claim 1, wherein spinning velocity is constant; progressively increasing; progressively decreasing; intermittent cycles of varying velocities; or cycles or combinations thereof.

11. The method of claim 1, wherein the spinning velocity is 600 to 10,000 revolutions per minute

12. The method of claim 1, wherein the plate comprises a defined height and comprises indentations comprising a plurality of separate or concentric shapes at progressively increasing depths.

13. The method of claim 1, wherein a plurality of thicknesses of a sunscreen on one or more plates are prepared.

14. An in vitro method for determining the SPF and absorbance or transmission spectra of a sunscreen, the method comprising:
(a) applying sunscreen onto a plate by spin coating;
(b) applying a continuous or intermittent light source to the sunscreen and plate; and
(c) measuring the transmission or absorbance of the sunscreen;
(d) calculating the integrated absorbance spectrum;
(e) analyzing the integrated absorbance spectrum; and
(f) determining the sun protection factor.

15. The method of claim 14, wherein spin coating creates precise, uniform, reproducible sunscreen films of pre-determined thickness values.

16. The method of claim 14, wherein the sunscreen is applied to the plate prior to initiating spinning.

17. The method of claim 14, wherein the sunscreen is applied to the plate after initiating spinning.

18. The method of claim 16, wherein sunscreen is continuously or intermittently applied.

19. The method of claim 14, wherein the sunscreen is diluted prior to application.

20. The method of claim 19, wherein the sunscreen is diluted with acetone, ether, methanol, ethanol, isopropanol, butanol, or other water-soluble or organic solvents.

21. The method of claim 14, wherein the sun protection factor, absorbance, or transmission spectra of the sunscreen of the sunscreen is unknown.

22. The method of claim 14, wherein the sunscreen is photolabile.

23. The method of claim 14, wherein spinning velocity is constant; progressively increasing; progressively decreasing; intermittent cycles of varying velocities; or cycles or combinations thereof.

24. The method of claim 14, wherein the spinning velocity is 600 to 10,000 revolutions per minute

25. The method of claim 14, wherein the plate comprises a defined height and comprises indentations comprising a plurality of separate or concentric shapes at progressively increasing depths.

26. The method of claim 14, wherein a time course of absorbance or transmission of the sunscreen is measured.

27. The method of claim 26, wherein an integrated absorbance spectrum is calculated.

28. The method of claim 14, wherein films of different thicknesses are prepared for a sunscreen.

29. The method of claim 28, wherein multiple absorbance spectra for individual sunscreen films of different thickness values are combined to yield the SPF and absorbance spectra of a sunscreen formula having an unknown SPF.

30. A plate for determining the SPF and absorbance or transmission spectra of a sunscreen.
